(19) United States
(12) Patent Application Publication
(10) Pub. No.: US 2025/0310725 A1
(43) Pub. Date: Oct. 2, 2025

(54) SYSTEM AND METHOD FOR SELECTING DEVICES FOR A LOCATION SYSTEM

(71) Applicants: DENSO International America, Inc., Southfield, MI (US); DENSO CORPORATION, Kariya-shi (JP)

(72) Inventors: Eric J. Smith, Holland, MI (US); Kyle Cooper, Plainwell, MI (US); Loren Vredevoogd, Holland, MI (US); Karl Jager, Zeeland, MI (US)

(21) Appl. No.: 18/955,296

(22) Filed: Nov. 21, 2024

Related U.S. Application Data
(60) Provisional application No. 63/570,538, filed on Mar. 27, 2024.

(51) Int. Cl. H04W 4/029; H04L 43/0817

(52) U.S. Cl. CPC H04W 4/029; H04L 43/0817

(57) ABSTRACT

A system and method are provided a selection, optionally dynamic, of a subset of sensors in a system for determining a location of a remote device relative to an object.

### FIELD OF INVENTION

The present disclosure relates to a system and method for communicating and localization of an object, such as a vehicle, and more particularly to communicating to determine the distance, location, and direction of a remote device with respect to another transmitter/receiver which could be mounted on an object, such as a vehicle.

### BACKGROUND

Real-time location or position determinations for objects have become increasingly prevalent across a wide spectrum of applications. Real-time locating systems (RTLS) are used and relied on for tracking objects, such as remote devices, in many realms including, for example, automotive, storage, retail, security access for authentication, and security access for authorization.

In conventional RTLS systems, the object includes several devices disposed in fixed positions on or about the object. These devices are sometimes described as anchors or object devices. The object devices may be operable to communicate with the remote device, and these communications may form the basis for a location determination for the remote device relative to the object. However, the communication protocol used for communications and the surrounding environment can impose significant limitations on the ability to communicate between the object devices and the remote device and/or to determine the location of the portable device. For instance, multipath fading and communication bandwidth can adversely affect efforts to determine a location of the remote device relative to the object.

### SUMMARY

In general, one innovative aspect of the subject matter described herein can be embodied in a system for determining a distance between a remote device and an object. The system may include a first device disposed in a fixed position relative to the object. The first device may be configured to conduct a first device ranging procedure with respect to the remote device based on communications with the remote device. The system may include a second device disposed in a fixed position relative to the object, where the second device may be operable to communicate with the first device. The system may include a control system configured to determine, based on communications between the first device and the second device, if the first device is acceptably operational for conducting the first device ranging procedure. The control system may be configured to direct the first device to abstain from conducting the first device ranging procedure based on the first device failing to be determined as acceptably operational for conducting the first device ranging procedure.

The foregoing and other embodiments can each optionally include one or more of the following features, alone or in combination. In particular, one embodiment includes all the following features in combination.

In some embodiments, the system may include a third device disposed in a fixed position relative to the object. The third device may be configured to conduct a third device ranging procedure with respect to the remote device based on communications with the remote device. The control system may be configured to determine, based on communications between the third device and the second device, if the third device is acceptably operational for conducting the third device ranging procedure. The control system may direct the third device to conduct the third device ranging procedure based on the third device being determined to be acceptably operational and direct the first device to abstain from conducting the first device ranging procedure based on the first device failing to be determined as acceptably operational for conducting the first device ranging procedure.

In some embodiments, the second device may be configured to conduct a second device ranging procedure with respect to the remote device based on communications with the remote device.

In some embodiments, the control system may be provided at least in part in a third device, and where the control system may be configured to determine, based on communications between the first device and the second device, if the second device is acceptably operational for conducting the second device ranging procedure.

In some embodiments, the control system may be operable to dynamically select one of the first and second devices to conduct the respective first and second device ranging procedures during a round of ranging procedures that includes more than one device conducting a ranging procedure with respect to the remote device.

In some embodiments, the control system may be provided at least in part in the second device.

In some embodiments, the control system may determine the first device has failed to be acceptably operational based on at least one of the first device malfunctioning, the first device having moved from a known location, and an antenna system of the first device is communicating in a manner out of specification.

In some embodiments, the first device and the second device each may include a backchannel interface operable to facilitate backchannel communications with the control system, and where the control system may be configured to determine at least one of the first and second devices fails to operate acceptably based on the backchannel communications failing to operate within acceptable parameters.

In general, one innovative aspect of the subject matter described herein can be embodied in a system for determining a distance between a remote device and an object. The system may include a plurality of devices disposed in a fixed position relative to the object. Each of the plurality of devices may be configured to conduct a ranging procedure with respect to the remote device based on communications with the remote device. The system may include a first device among the plurality of devices. The first device may be configured to conduct a first device ranging procedure with respect to the remote device based on communications with the remote device. The system may include a control system configured to direct dynamic selection of a subset of the plurality of devices to conduct the respective ranging procedures based on communications with the remote device during a ranging round. The control system may be configured to select the first device to be within the subset of the devices based on a performance metric pertaining to communications between the first device and at least one of the remote device and a second device disposed in a fixed position relative to the object.

The foregoing and other embodiments can each optionally include one or more of the following features, alone or in combination. In particular, one embodiment includes all the following features in combination.

In some embodiments, the second device may be one of the plurality of devices configured to conduct a ranging procedure with respect to the remote device based on communications with the remote device.

In some embodiments, the control system may be configured to exclude the first device from the subset of the devices based on the performance metric.

In some embodiments, a performance metric may be determined for communications for each of the plurality of devices.

In some embodiments, the second device may include the control system.

In some embodiments, performance metric may be determined between ranging rounds, and where the control system may be operable to select a new subset of the plurality of devices between each ranging round.

In some embodiments, the performance metric may be determined during a ranging round, and where the control system may be operable to determine whether to include the first device in the subset of devices during the ranging round.

In some embodiments, the performance metric may be determined prior to an initial ranging round.

In some embodiments, the control system may direct the first device to conduct the

first device ranging procedure more than once during a ranging round.

In some embodiments, the control system may be configured to determine if the first device is acceptably operational for conducting the first device ranging procedure.

In some embodiments, the control system may be configured to determine if the first device is acceptably operational based on the performance metric.

In some embodiments, the control system may be configured to determine if each of the plurality of devices is acceptably operational for conducting a ranging procedure and to exclude from the subset of the plurality of devices any of the plurality of devices that fail to be determined as acceptably operational.

In general, one innovative aspect of the subject matter described herein can be embodied in a system for determining a distance between a remote device and an object. The system may include a plurality of devices disposed in a fixed position relative to the object. Each of the plurality of devices may be configured to conduct a ranging procedure with respect to the remote device based on communications with the remote device. The system may include a first device among the plurality of devices. The first device may be configured to conduct a first device ranging procedure with respect to the remote device based on communications with the remote device. The first control system may be configured to direct dynamic selection of a subset of the plurality of devices to conduct the respective ranging procedures based on communications with the remote device during a ranging round. The control system may be configured to determine if the first device is acceptably operational for conducting the first device ranging procedure. The control system may be configured to select the first device to be within the subset of the devices based on 1) the first device being acceptably operational and 2) a performance metric pertaining to communications between the first device and at least one of the remote device and a second device disposed in a fixed position relative to the object.

The foregoing and other embodiments can each optionally include one or more of the following features, alone or in combination. In particular, one embodiment includes all the following features in combination.

In some embodiments, the control system may determine the first device has failed to be acceptably operational based on at least one of the first device malfunctioning, the first device having moved from a known location, and an antenna system of the first device is communicating in a manner out of specification.

In some embodiments, each of the plurality of devices may include a backchannel interface operable to facilitate backchannel communications with the control system. The control system may be configured to determine the first device fails to operate acceptably based on the backchannel communications failing to operate within acceptable parameters.

In some embodiments, the second device may be one of the plurality of devices configured to conduct a ranging procedure with respect to the remote device based on communications with the remote device.

In some embodiments, the control system may be configured to exclude the first device from the subset of the devices based on the performance metric.

In some embodiments, a performance metric may be determined for communications for each of the plurality of devices.

In some embodiments, the performance metric may be determined between ranging rounds, and where the control system may be operable to select a new subset of the plurality of devices between each ranging round.

In some embodiments, the performance metric may be determined during a ranging round, and where the control system may be operable to determine whether to include the first device in the subset of devices during the ranging round.

In some embodiments, the performance metric may be determined prior to an initial ranging round.

In some embodiments, the control system may direct the first device to conduct the first device ranging procedure more than once during a ranging round.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows a system in accordance with one embodiment.

FIG. 2 shows a system in accordance with one embodiment.

FIG. 3 shows an object device in accordance with one embodiment.

FIG. 4 shows a method of operation according to one embodiment.

FIG. 5 shows the system of FIG. 1 after an event has caused non-compliant movement.

FIG. 6 shows a system in accordance with one embodiment.

### DETAILED DESCRIPTION

A system and method selection, optionally dynamic, of a subset of sensors in a system for determining a location of a remote device relative to an object are provided.

In one embodiment, a self-check system is provided for a system adapted to determine a location of a remote device relative to an object. The system may utilize one or more communication protocols for determining location of the remote device, including ultra-wide band (UWB) and/or Bluetooth LE (BLE) High Accuracy Distance Measurement (HADM) protocols. The system may include a plurality of sensors or anchors installed on a vehicle (including inside the vehicle), and the system may be configured to determine which anchors are operating and which are not. For instance, non-operational object devices may include object devices operating out of specification or adversely affected by fading effects or environmental factors. An object device operating out of specification may have one or more antennas that are configured or operating in a manner inconsistent with specified operation for the one or more antennas, including an antenna having a radiation pattern that is significantly different from a specified radiation pattern.

In one embodiment, as described herein, the anchors or sensors may be communicatively connected to another device (e.g., a sensor or object device) via a backchannel that may be wired or wireless. For instance, the backchannel configuration may be a wired CAN-based communication configuration. As another example, the backchannel configuration may be based on LIN, UART, BLE, UWB or any other one or more communication protocols. The anchors may communicate with a remote device, potentially via BLE (RSSI, HADM, AoA) or UWB. In one embodiment, as described herein, each anchor has at least a UWB or BLE radio, or both. The system may be configured to use time of flight (ToF)—UWB or BLE HADM—and the system may be configured for either one remote device, for one anchor×N ToF measurements, or one remote device for N anchors×1 broadcast time-synchronized time difference of arrival (TDoA).

The remote device may be an initiator and each of the anchors may be responders—so the anchors only transmit with the remote device as part of a ranging exchange. In the case of BLE RSSI or AoA sniffing, the anchors may not transmit at all (except for perhaps a wireless backchannel communication scheme).

In one embodiment, a system and method are provided to communicate among devices in a system operable to determine a range and direction between a first device (e.g., a first object device) and a remote device based on a characteristic of the communications transmitted between the first device and the remote device. The first device, in one embodiment, may be provided on the object and may be configured to receive wireless communication signals from a remote device in accordance with a device signaling protocol. The first device may also include a first communication interface operable to transmit and receive communication signals via a physical medium, where the first communication interface is configured to communicate via the physical medium in accordance with a signaling protocol, which may or may not be the same as the device signaling protocol for wireless communications.

A second device may be provided on the object, and may be configured to receive wireless communication signals from the remote device in accordance with the device signaling protocol. The second object may include a second communication interface operable to transmit and receive communication signals with the first object device via the physical medium, where the second communication interface may be configured to communicate via the physical medium in accordance with a signaling protocol, which may not be the same as the device signaling protocol for wireless communications.

Although communication between the first and second device is described as being conducted via a physical medium, it should be understood that the present disclosure is not so limited. Such communication may be established via wireless communication, similar to wireless communication with the remote device.

In one embodiment, a control system may be provided to obtain signal information pertaining to the wireless signals received from the remote device. The control system may determine a range of the remote device relative to the object based on the signal information, wherein the signal information is transmitted from the second object device to the first object device via the physical medium in accordance with the device signaling protocol.

### I. Location System Overview

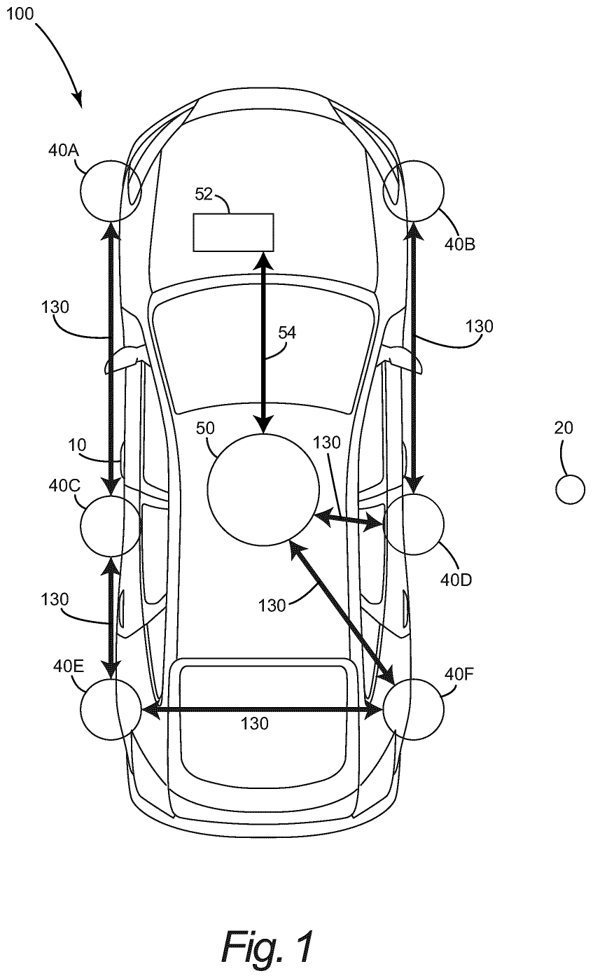

A system in accordance with one embodiment is shown in the illustrated embodiment of FIG. 1 and generally designated 100. The system 100 may include one or more system components as outlined herein. A system component may be a user or an electronic system component, which may be the remote device 20, a sensor 40 (also designated 40A, 40B, 40C, 40D, 40E, 40F), or an object device 50, or a component including one or more aspects of these devices. Several aspects of the remote device 20, the sensor 40, and the object device 50 may be similar. The primary difference between the object device and the sensor pertains to the role of the device within the system 100—e.g., the object device 50 may transmit data to and receive data from the sensor 40 via a communication link 130. The object device 50 may direct operation of the sensor 40 by transmitting data to the sensor 40. The object device 50 may obtain, via the communication link 130, information from the sensor 40 indicative of a position of the remote device 20 relative to the sensor 40 and/or the object 10. One or more or all features described in connection with the sensor 40 in the illustrated embodiments may be incorporated into the remote device 20.

In one embodiment, the sensor 40 and the object device 50 may form at least part of a system 100 disposed on an object 10, such as a vehicle or a building. The object device 50 may be communicatively coupled to one or more systems of the object 10 to control operation of the object 10, to transmit information to the one or more systems of the object 10, or to receive information from the one or more systems of the object 10, or a combination thereof. For instance, the object 10 may include an object controller 52 configured to control operation of the object 10. The object 10 may include one or more communication networks 54, wired or wireless, that facilitate communication between the object controller 52 and the object device 50. The communication network 54 for facilitating communications between the object device 50 and the object controller 52 may be a CAN bus; however, it is to be understood that the communication network is not so limited. The communication network may be any type of network, including a wired or wireless network, or a combination of two or more types of networks.

The one or more sensors 40 may be disposed in a variety of positions on the object 10, such as the positions described herein, including for instance, one or more sensors 40 in the door panel and one or more other sensors in the B pillar.

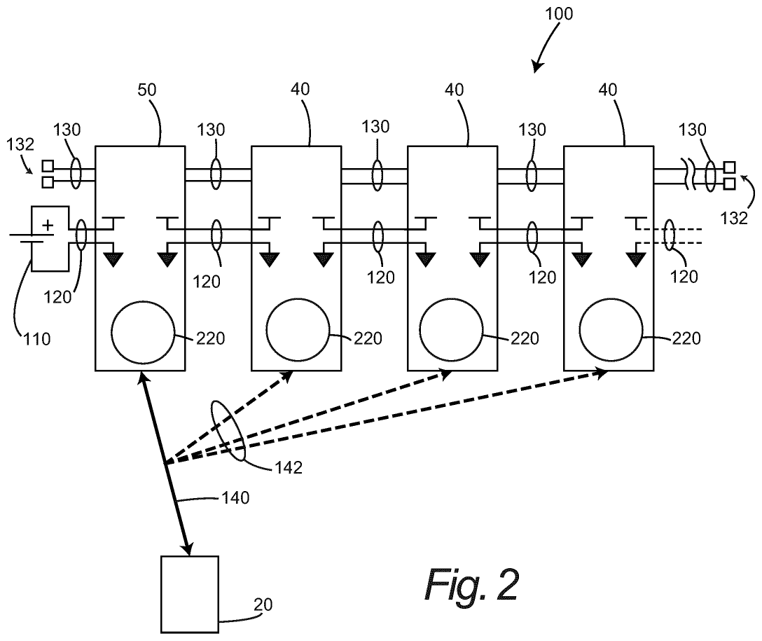

The object device 50 and the one or more sensors 40 may be powered via a power bus 120 and power source 110. The power bus 120 may be daisy-chained from one device to the next as depicted in the illustrated embodiment of FIG. 2. Alternatively, the power bus 120 may be provided in the form of a star connection with power being supplied from one location to multiple locations via separate connections. Power supply and architecture is not limited to any one type—for instance, power may be distributed via both a daisy chain and star connection configurations.

The system 100 in the illustrated embodiment may be configured to determine location information in real-time with respect to the remote device 20. In the illustrated embodiment of FIG. 1, a user may carry the remote device 20 (e.g., a smartphone). The system 100 may facilitate locating the remote device 20 with respect to the object 10 (e.g., a vehicle) in real-time with sufficient precision to determine whether the user is located at a position at which access to the object 10 or permission for an object 10 command should be granted.

For instance, in an embodiment where the object 10 is a vehicle, the system 100 may facilitate determining whether the remote device 20 is outside the vehicle but in close proximity, such as within 5 feet, 3 feet, or 2 feet or less, to the driver-side door. This determination may form the basis for identifying whether the system 100 should unlock the vehicle. On the other hand, if the system 100 determines the remote device 20 is outside the vehicle and not in close proximity to the driver-side door (e.g., outside the range of 2 feet, 3 feet, or 5 feet), the system 100 may determine to lock the driver-side door. As another example, if the system 100 determines the remote device 20 is in close proximity to the driver-side seat but not in proximity to the passenger seat or the rear seat, the system 100 may determine to enable mobilization of the vehicle. Conversely, if the remote device 20 is determined to be outside close proximity to the driver-side seat, the system 100 may determine to immobilize or maintain immobilization of the vehicle.

The object 10 may include multiple object devices 50 or a variant thereof, such as an object device 50 and a sensor 40 coupled to an antenna assembly 220, in accordance with one or more embodiments described herein. The object device 50 or the sensor 40, or both, may include one or more antenna assemblies and may be configured in a variety of ways to facilitate wireless communications.

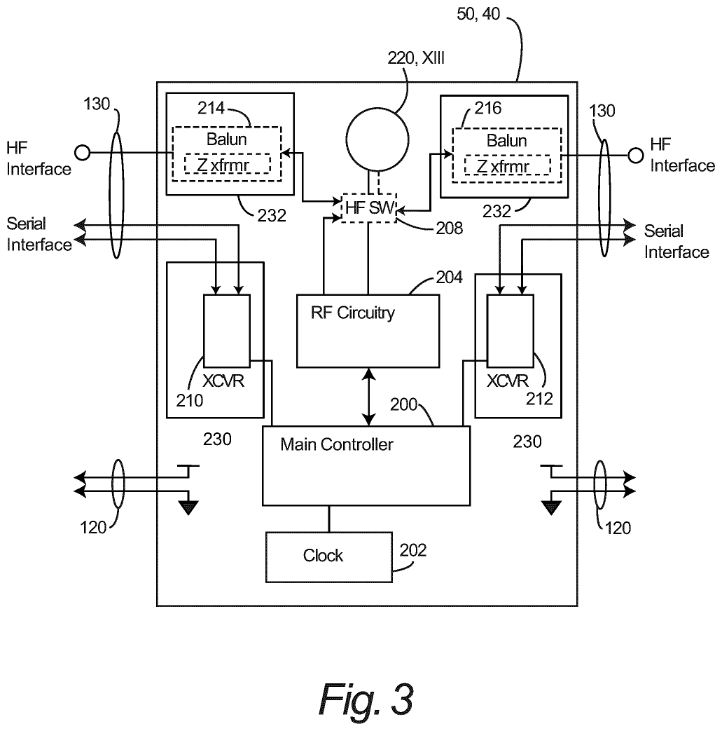

In one embodiment, the object device 50 may be configured to communicate directly with one or more sensors 40 via the communication link 130, which as described herein, may include one or more interfaces, such as both a high frequency (HF) interface 232 and a serial interface 230. The one or more interfaces may be established via one or more physical mediums—for instance, in the case of both a HF interface 232 and a serial interface 230 as depicted in FIG. 3, the HF interface 232 may be established via a physical medium in the form of coax or twisted pair conductors, and the serial interface 230 may be established via a physical medium in the form of twisted pair conductors. As another example, both the HF interface 232 and the serial interface 230 may be established via the same physical medium, which may be a twisted pair of conductors. Alternatively, the HF interface 232 or the serial interface 230, or both, may utilize wireless communication.

In the illustrated embodiment of FIG. 2, the communication link 130 is distributed from one device to another and includes a terminator 132 at each end. The communication link 130 among the devices may be a shared link or a separate link for each device, or a combination thereof. For instance, the communication link 130 may be shared among two or more devices as depicted, and additionally or alternatively, the communication link 130 may be established separately from one device to another device. A device may communicate via more than one separate communications link 130, and may be configured to relay communications from one communication link 130 to another communication link 130.

In addition to or alternative to one or more location techniques described herein, micro-location of the remote device 20 may be determined in a variety of ways, such as using information obtained from a global positioning system, one or more signal characteristics of communications from the remote device 20, and one or more sensors (e.g., a proximity sensor, a limit switch, or a visual sensor), or a combination thereof. An example of microlocation techniques for which the system 100 can be configured are disclosed in U.S. Nonprovisional patent application Ser. No. 15/488,136 to Raymond Michael Stitt et al., entitled SYSTEM AND METHOD FOR ESTABLISHING REAL-TIME LOCATION, filed Apr. 14, 2017—the disclosure of which is hereby incorporated by reference in its entirety.

In the illustrated embodiment of FIGS. 1-3, the object device 50 (e.g., a system control module (SCM)) and a plurality of sensors 40 (each coupled to an antenna assembly 220 as shown in FIG. 3) may be disposed on or in a fixed position relative to the object 10. Example use cases of the object 10 include the vehicle identified in the previous example, or a building for which access is controlled by the object device 50.

The remote device 20 may communicate wirelessly with the object device 50 via a communication link 140, such as a Bluetooth communication link (e.g., standard Bluetooth, Bluetooth Low Energy (BTLE), or BTLE High Accuracy Distance Measurement (BTLE-HADM)) or BTLE channel sounding (BTLE-CS) an Ultra Wideband (UWB) communication link. The plurality of sensors 40 may be configured to sniff the communications of the communication link 140 between the remote device 20 and the object device 50 as shown in phantom lines 142. The sniffed communications or transmissions may correspond to a tone exchange (one-way or two-way) between the object device 50 and the remote device 20. Based on the sniffed communications, a sensor 40 may determine one or more signal characteristics of the communications as described herein, including a phase characteristic of the communications. Additional or alternative signal characteristics include a signal strength, time of arrival, time of flight, angle of arrival, or a combination thereof. The determined signal characteristics may be communicated or analyzed and then communicated to the object device 50 via the communication link 130 separate from the communication link 140 between the remote device 20 and the object device 50.

Additionally, or alternatively, the remote device 20 may establish a direct communication link with one or more of the sensors 40, and the one or more signal characteristics may be determined based on this direct communication link. For instance, the remote device 20 and a sensor 40 may perform a tone exchange as a basis for determining a distance between the sensor 40 and the remote device 20. The tone exchange may form the basis of an analysis of a phase difference in communications, and this phase difference may be a basis for determining a time of flight and therefore range of the remote device 20.

As discussed herein, a location system may receive one or more inputs that may vary from application to application. Examples of inputs include one or more signal characteristics of the communications, such as signal strength (RSSI), angle of arrival (AOA), time of flight (TOF), time of arrival, a phase characteristic, a phase-based ranging procedure of BLE channel sounding (CS), a velocity estimate of a phase-based ranging procedure of BLE CS, and a range estimate of a round trip time (RTT) procedure of BLE CS. The one or more signal characteristics may be analyzed to determine location information about the remote device 20 relative to the object 10, an aspect of the object 10, or the object device 50, or a combination thereof.

For instance, a phase rotation of a tone transmission, and optional re-transmission, or a phase characteristic indicative of a phase rotation may form the basis for determining a distance between an object device 50 or a sensor 40 and the remote device 20. The tone transmission may form part of a tone exchange in which a plurality of transmissions is conducted according to multiple frequencies. A phase rotation with respect to such transmissions may form the basis for a distance determination with respect to the object device 50 and the remote device 20. The tone exchange may be described as a channel sounding approach (e.g., BLE channel sounding (CS)) for determining a range or distance between devices (e.g., between the object device 50 and the portable device 20).

With respect to an electromagnetic wave traveling at the speed of light in a particular medium (e.g., air), an amount of phase rotation may be translatable to a distance or a time. In one embodiment, an RTT may be determined with respect to transmissions to and from a device, such as the remote device 20, via measurement of a phase characteristic or a time characteristic. In other words, two-way transmissions to and from the remote device 20 may be analyzed to determine a roundtrip time, which can be translated as a time of flight.

Because the wavelength for high frequency transmissions can be short relative to the target distance being measured, the transmissions wrap or complete full phase rotations such that total phase rotation embodied as the total distance cannot be measured directly from a phase in the input stage of the RF circuitry (e.g., by a mixer stage). For instance, for a carrier frequency at 2.4 GHz, the phase rotation wraps around 2π with d in the range of 12 cm. A phase measurement may indicate a phase within the range 0-2π, but the phase measurement does not directly indicate the number of phase rotation wraps.

To measure longer distances without ambiguity, two different frequencies (f0, f1) can be used at two different instants i in time (i0, i1) to compute two different phase rotations. The two different phase rotations can be used to measure the distance. A phase-based distance determination is described in conjunction with two different frequencies—however, it is to be understood that phase measurements for a plurality of frequencies (including more than two frequencies) may be used to enhance accuracy of the distance determination. The use of multiple frequencies in the phase analysis may be considered a type of channel sounding approach to determine distance between devices. The locator in one embodiment may translate the signal characteristic obtained from a remote device 20 or the object device 50 to a distance metric or other parameter in a variety of ways, including, for instance, a translation table for each fixed position device or type of fixed position devices, fingerprinting or other heuristic (e.g., a machine learned translator). Additional examples of such a translation are described in U.S. Pub. 2020/0137817, entitled SYSTEM AND METHOD OF DETERMINING REAL-TIME LOCATION, filed Oct. 23, 2019, to Smith—the disclosure of which is hereby incorporated by reference in its entirety.

In one embodiment, the direct communication link may be established according to the BTLE protocol; however, the present disclosure is not so limited—the direct communication link may be any type of link or links, including UWB or BTLE-HADM.

It is to be understood that an object 10, such as a vehicle, may include a number of sensors 40 that can be greater than or less than the number shown in the illustrated embodiment of FIGS. 1 and 2. Depending on the implementation, some number of sensors 40 may be integrated in a vehicle.

As described herein, one or more signal characteristics, such as a phase characteristic, a signal strength, time of arrival, time of flight, and angle of arrival, may be analyzed to determine location information about the remote device 20 relative to the object 10, an aspect of the object 10, or the object device 50, or a combination thereof. For instance, a phase rotation of a tone transmission, and optional re-transmission, or a phase characteristic indicative of a phase rotation may form the basis for determining a distance between an object device 50 or a sensor 40 and the remote device 20. Additional examples of signal characteristics include time difference of arrival or the angle of arrival, or both, among the sensors 40 and the object device 50 may be processed to determine a relative position of the remote device 20. The positions of the one or more antenna assemblies 220 relative to the object device 50 may be known so that the relative position of the remote device 20 can be translated to an absolute position with respect to the antenna assemblies 220 and the object device 50.

Additional or alternative types of signal characteristics may be obtained to facilitate determining position according to one or more algorithms, including a distance function, trilateration function, a triangulation function, a lateration function, a multilateration function, a fingerprinting function, a differential function, a time of flight function, a time of arrival function, a time difference of arrival function, an angle of departure function, a geometric function, or any combination thereof.

### II. System Device Overview

In the illustrated embodiment of FIG. 3, the object device 50 is shown in further detail. The structure and configuration of the object device 50 may be incorporated into the object device 50, so the sensor 40 is also referenced as the object device 50 in the illustrated embodiment.

The object device 50 in the illustrated embodiment of FIG. 3 includes several components, one or more of which may be provided in a commercial embodiment. The object device 50 in some instances may be described as an anchor disposed on the object 10.

The object device 50 may include RF circuitry 204 operable to control transmission and reception of HF signals. The RF circuitry 204 may be operably coupled to an antenna assembly 220, which may include one or more antennas. Optionally, multiple antenna assemblies 220 may be utilized to provide spatial diversity such that they do not receive the same waves. For instance, each of the plurality of antennas may be disposed at different locations to provide spatial diversity. As another example, the plurality of antennas may have different slant polarizations (e.g., circular polarization with lead or lag relative to each other).

The RF circuitry 204 may be configured to supply or receive high-frequency signals from the antenna assembly 220 via a HF switch 208. As described herein, the antenna assembly 220 may include filter circuitry that may condition the signal output from the RF circuitry 204 for driving the antenna assembly 220. Conversely, the filter circuitry may condition a signal received from the antenna assembly 220 for processing by the RF circuitry 204. The HF switch 208 may selectively direct input and output of HF signals, including HF signals supplied to and received from the antenna assembly 220.

In one embodiment, the RF circuitry 204 may be configured according to one embodiment to transmit and receive signals via HF interface 232 of the communication link 130. Transmission and reception of HF signals in one embodiment may enable an object device 50 to communicate via a physical medium according to a communication protocol that is different, the same or similar to the one utilized by the antenna assembly 220 in the RF circuitry 204. For instance, the object device 50 may transmit and receive communications via a physical medium defined by the HF interface 232 that correspond to the BTLE communications, while also transmitting and receiving communications via the antenna assembly 220 that correspond to BTLE communications.

The HF switch 208 may selectively direct output from the RF circuitry 204 to the HF interface 232 of the communication link 130, and selectively direct input from the HF interface 232 of the communication link 130 to the RF circuitry 204. In one embodiment, the HF interface 232 may be a single ended configuration, such as a coaxial conductor arrangement. Alternatively, the HF interface 232 may be differential, and optionally include conditioning circuitry 214, 216 (e.g., a balun and/or an impedance transformer) for translating between a single ended output from the HF switch 208 and a differential output of the HF interface 232.

In the illustrated embodiment, the object device 50 is configured to transmit and receive communications via separate HF interfaces 232 provided by separate communication links 130. In other words, the two communication links 130 in the illustrated embodiment are isolated from each other, such that communications received on one communication link 130 are not inherently transmitted or seen on the other communication link 130. As discussed herein, the object device 50 may be configured to relay communications from one of the communication links 130 to the other of the communication links 130. For example, communications received via one high-frequency interface may be directed to the RF circuitry 204, and may be relayed to the other high-frequency interface via the RF circuitry 204. The HF switch 208 may be configured to transition from one state to another state to facilitate relaying of such communications. It is to be understood, however, that in one or more embodiments described herein, communications transmitted via one of the communication links 130 may inherently pass to the other of the communication links 130.

The object device 50 may include a main controller 200 and may be configured to direct operation of the RF circuitry 204, as described herein. In one embodiment, the main controller 200 may control communications with the remote device 20 and optionally obtain one or more sensed characteristics with respect to such communications to be used as a basis for ranging the remote device 20. Additionally, or alternatively, the object device 50 may sniff communications between a sensor 40 and the remote device 20 and obtain one or more sensed characteristics with respect to the sniffed communications.

The main controller 200 may further direct transmission and reception of communications via the HF interface 232 of the one or more communication links 130. As an example, the main controller 200 may direct transmission and reception of BTLE communications via the HF interface 232 of the communication link 130. Information transmitted via the HF interface 232 of the communication links 130 may relate to one or more signal characteristics obtained with respect to communications received and/or transmitted via the antenna assembly 220. As an example, the information transmitted via the communication link 130 may be indicative of a sensed characteristic determined with respect to communications received and/or transmitted via the antenna assembly 220.

Additionally, or alternatively, the main controller 200 may utilize the high-frequency interface of the communication links 130 for time synchronization purposes. A sensed characteristic of communications may be based at least in part on a time reference of the device. And because time is translatable to distance (and conversely distance to time) with respect to electromagnetic waves, controlling the reference time of the sensor 40 may facilitate enhancing accuracy with respect to determining the distance between the remote device 20 and the object device 50.

The object device 50 may include a clock 202 that operates an oscillator for the sensor 40 and generates one or more timing signals for operation of aspects of the object device 50, including the main controller 200 and the RF circuitry 204.

In one embodiment, the main controller 200 may be configured to initially synchronize one or more timing signals provided by the clock 202 based on synchronization-related communications received via the high-frequency interface of the communication links 130. To provide an example, in the context of the sensor 40 including the main controller 200 and the clock 202, the object device 50 may transmit synchronization-related communications to the sensor 40 to facilitate substantially synchronizing timing signals between the object device 50 and the sensor 40. This way, sensed characteristics determined by the sensor 40 and the object device 50 may be compared or related to each other against substantially the same time reference.

In the illustrated embodiment, the object device 50 may include first and second transceivers 210, 212 coupled respectively to serial interfaces of the communication links 130. The transceivers 210, 212 may be CAN transceivers, but the present disclosure is not so limited. The transceivers 210, 212 may facilitate any type of serial or non-serial communications via the communication links 130, including but not limited to RS-485, LIN, Vehicle Area Network (VAN), Fire Wire, I2C, RS-232, RS-485, and Universal Serial Bus (USB).

The first and second transceivers 210, 212 may enable communications among devices (e.g., the object device 50 and a sensor 40) for information that is less time sensitive. For instance, the object device 50 may transmit to a sensor 40, via the serial interface of the communication link 130, connection parameters for the communication link 140 to enable the sensor 40 to sniff or monitor communications between the object device 50 and the remote device 20. A sensor 40 may receive such communications via the first transceiver 210 and relay the communications to another device (e.g., another sensor 40) via the second transceiver 212.

Optionally, the object device 50 may include a communication link 130 configured with a serial interface without the high-frequency interface or a high-frequency interface without the serial interface. Communications described herein with respect to one interface and not the other may be communicated via the interface provided by the communication link 130. For instance, the communication link 130 may include a high-frequency interface without the serial interface, and communications described in connection with the serial interface may be transmitted via the high-frequency interface.

The main controller 200 may include electrical circuitry and components to carry out the functions and algorithms described herein. Generally speaking, the main controller 200 may include one or more microcontrollers, microprocessors, and/or other programmable electronics that are programmed to carry out the functions described herein. The main controller 200 may additionally or alternatively include other electronic components that are programmed to carry out the functions described herein, or that support the microcontrollers, microprocessors, and/or other electronics. The other electronic components include, but are not limited to, one or more field programmable gate arrays (FPGAs), systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the object device 50, or they may reside in a common location within the object device 50. When physically distributed, the components may communicate using any suitable serial or parallel communication protocol, such as, but not limited to, CAN, LIN, Vehicle Area Network (VAN), Fire Wire, I2C, RS-232, RS-485, and Universal Serial Bus (USB).

As described herein, the main controller 200 may be configured to determine a location or range of a portable device 20 relative to an object 10. The main controller 200 may include a locator, module or model, or a combination thereof, operable to determine the location or range based on one or more signal characteristics. For instance, a model for determining a range or location, in one embodiment, may include one or more core functions and one or more parameters that affect output of the one or more core functions. Aspects of the model may be stored in memory of the main controller 200, and may also form part of the controller configuration such that the model is part of the main controller 200 that is configured to operate to receive and translate one or more inputs and to output one or more outputs. Likewise, a module or a locator are parts of the main controller 200 such that the main controller 200 is configured to receive an input described in conjunction with a module or locator and provide an output corresponding to an algorithm associated with the module or locator.

The main controller 200 of the object device 50 in the illustrated embodiment of FIG. 3 may include one or more processors that execute one or more applications (software and/or includes firmware), one or more memory units (e.g., RAM and/or ROM), and one or more communication interfaces, amongst other electronic hardware. The object device 50 may or may not have an operating system that controls access to lower-level devices/electronics via a communication interface. The object device 50 may or may not have hardware-based cryptography units-in their absence, cryptographic functions may be performed in software. The object device 50 may or may not have (or have access to) secure memory units (e.g., a secure element or a hardware security module (HSM)).

The main controller 200 in the illustrated embodiment of FIG. 3 is not dependent upon the presence of a secure memory unit in any component. In the optional absence of a secure memory unit, data that may otherwise be stored in the secure memory unit (e.g., private and/or secret keys) may be encrypted at rest. Both software-based and hardware-based mitigations may be utilized to substantially prevent access to such data, as well as substantially prevent or detect, or both, overall system component compromise. Examples of such mitigation features include implementing physical obstructions or shields, disabling JTAG and other ports, hardening software interfaces to eliminate attack vectors, using trusted execution environments (e.g., hardware or software, or both), and detecting operating system root access or compromise.

For purposes of disclosure, being secure is generally considered being confidential (encrypted), authenticated, and integrity-verified. It should be understood, however, that the present disclosure is not so limited, and that the term “secure” may be a subset of these aspects or may include additional aspects related to data security.

The communication interface of the main controller 200 may facilitate any type of communication link, including any of the types of communication links described herein, including wired or wireless. The communication interface may facilitate external or internal, or both, communications. For instance, the communication interface may be coupled to the RF circuitry 204 to enable communications via one or more of the antenna assembly 220 and the HF interface 232 of the communication link 130.

As another example, the communication interface of the main controller 200 may facilitate a wireless communication link with another system component in the form of the remote device 20, such as wireless communications according to the WiFi standard or UWB, or any combination thereof. As another example, the communication interface of the main controller 200 may include a display and/or input interface for communicating information to and/or receiving information from the user.

In one embodiment, the object device 50 may be configured to communicate with one or more auxiliary devices of a type different from the remote device 20 or the sensor 40. In other words, the auxiliary device may be configured differently from the object device 50. For instance, the auxiliary device may not include a processor, and instead, may include at least one direct connection and/or a communication interface for transmission or receipt, or both, of information with the object device 50. The auxiliary device may be a solenoid that accepts an input from the object device 50, or the auxiliary device may be a sensor (e.g., a proximity sensor) that provides analog and/or digital feedback to the object device 50.

### III. Anchor Selection

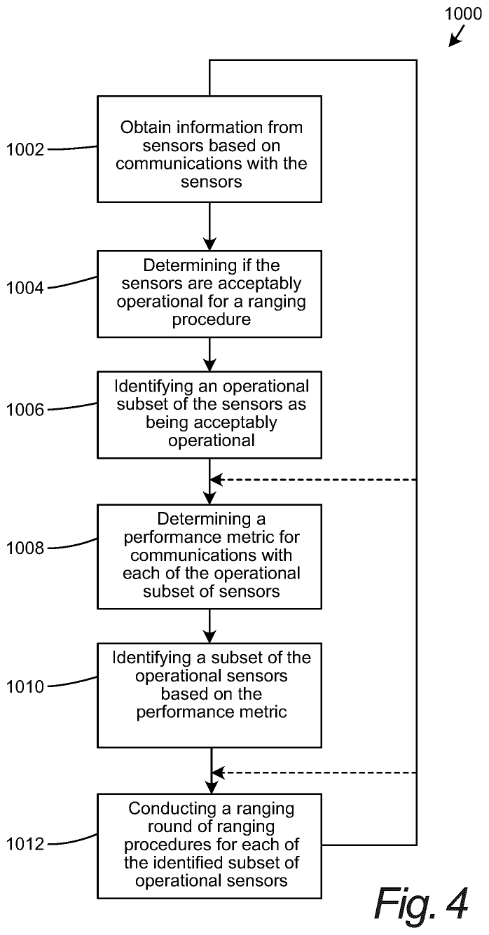

In one embodiment of the present disclosure, the system 100 may include a self-check system or anchor selection system adapted to determine which of a set of anchors to utilize for a location determination for the remote device 20 relative to the object 10. A method of selecting anchors according to one embodiment is shown in FIG. 4 and designated 1000.

In one embodiment, the anchor selection system may be operable to configure a constellation of anchors or sensors 40, such that one or more sensors are able to “communicate” with each of the sensors 40, and then when performing the self-test or selection algorithm, these sensors 40 may act as an initiator and each of the other sensors 40 may operate as responders.

If there is more than one sensor 40 in the constellation, the system 100 may be configured for sensors 40 to be operated sequentially as initiators, or the sensors 40 of the system 100 may be operated as initiators in an overlapping manner (essentially simultaneously). Each initiator may determine or record distance measurements and other signal metrics (e.g., RSSI, first path power, channel impulse response, etc.) from each of the sensors 40 and note if any sensors 40 did not observe the initiator. The system 100 may then be configured to analyze these results to determine if individual sensors 40 are able to communicate via the RF interface (UWB, BLE HADM) and on the backchannel (e.g., the communication link 130).

### A. Operational Sensor Selection

In one embodiment, one sensor 40 may not know whether each of the other sensors 40 are able to communicate over the backchannel, because it may not be connected directly to the sensor 40 operating as an initiator-so a controller 200 of the system 100 may determine whether a sensor 40 is able to communicate on the backchannel instead of the initiator; however, there may be configurations where the initiator may determine this as well (such as a broadcast bus design, like CAN). This information may be sent back to the controller 200 to analyze the results. The controller 200 may process the results in their entirety-or the sensor 40 operating as an initiator may send a summary to the controller 200 (i.e., which sensors 40 are missing and/or out of spec). Because the system 100 may include a priori knowledge of an intended distance between each of the sensors 40, the system 100 may detect whether a sensor 40 is malfunctioning, has been moved, or has been tampered with (or is blocked/attenuated, for example) based on a mismatch of known distance or other signal metrics to the measured distance, any of which may be considered to be out of specification operation. Steps 1002, 1004. With this, for example, the system 100 may detect a sensor 40 whose radio has failed, but whose backchannel communication interface (e.g., a CAN interface) has not failed. The system 100, in one embodiment, may detect when a sensor 40 has been moved (either due to a collision-or a security attack where someone has purposefully moved a sensor 40 to a different location). From the data, the controller 200 may generate a test report, which may correspond to a simple pass/fail for the system 100 and/or for each sensor 40, or the test report may incorporate, using all of the available data, prognostics to identify when sensors 40 are starting to fail but have not yet failed.

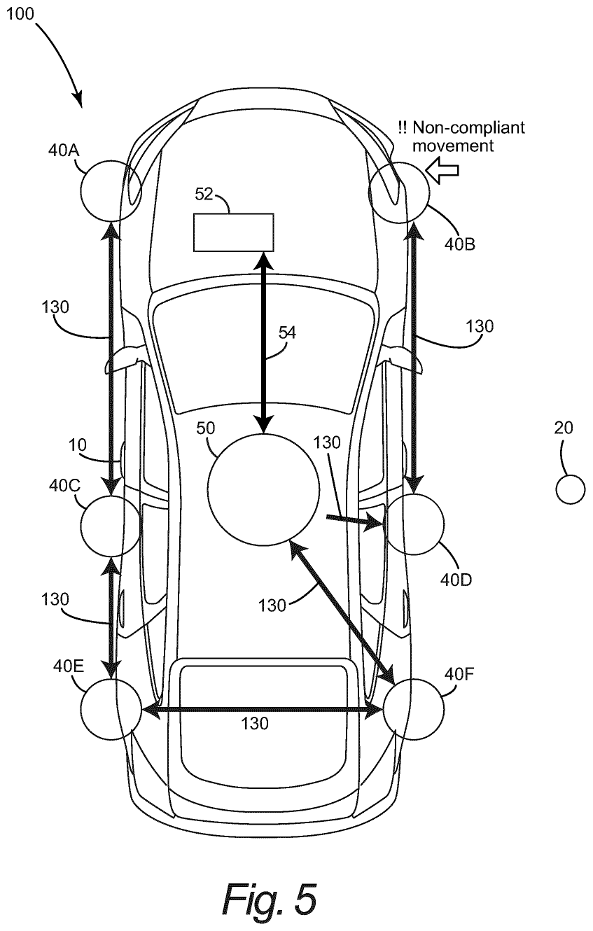

As an example, FIG. 5 shows the system of FIG. 1 with a sensor 40B being non-compliant. The sensor 40B in the illustrated embodiment has been moved due to a collision, causing the sensor 40B to report information that is inconsistent with expected information.

In one embodiment, the test report may be sent to another system component—either another connected vehicle ECU (for example, to trigger a diagnostic trouble code [DTC], for HMI display to the user, for logging in a cloud service, etc.) or a remote device 20 (when connected) to notify a vehicle user.

In one embodiment, based on the test report (e.g., results) from the initiator, a controller 200 of the system 100 may determine a set of sensors 40 to use for a determination of a location of the remote device 20 relative to the object 10. Step 1004.

In one embodiment, the system 100 may encounter a configuration in which a sensor 40 acting as an initiator may fail, and so using multiple sensors 40 operating as initiators may be utilized to mitigate such a potential failure. In this case, with multiple initiators, a controller 200 may obtain the results from each of the initiators and generate a report that consolidates all of the information. Based on the results from each of the initiators, a controller 200 of the system 100 may determine a set of sensors 40 to use for a determination of a location of the remote device 20 relative to the object 10.

In one embodiment, each of the sensors 40 in the system 100 may be operated as an initiator. It is unlikely that each sensor 40 may be able to observe communications from each other sensor 40 in the system 100. Therefore, in this embodiment, where each sensor 40 in the system 100 takes a turn as the initiator, each sensor 40 then sends the information it gathers to a controller 200 to consolidate and build a report.

In one embodiment, anchor selection mode may involve being executed in any combination of: on power on, when commanded (e.g., via diagnostic tool or by user via vehicle or mobile HMI, when some event occurs requiring the test as determined by the vehicle [e.g., collision, vehicle test, etc.]), or periodically (e.g., when the system is not in use or at an opportune time during use).

In one embodiment, a localization algorithm may be selected based on the determination of the self-test check or anchor selection methodology. For example, a machine-learning (ML) model built with a non-working front left anchor may be selected and used. Or a different set of heuristics may be utilized.

Additionally, or alternatively, the system 100 may configure itself (e.g., use a set of sensors 40) and may prevent certain zones/determinations or limit itself to certain modes of operation (RKE only, no passive localization). Use cases include: the system 100 being conducted for evaluation during manufacturing, service diagnostics, or just normal Built-In-Test operations.

The system 100, in one embodiment, may know the expected results of the anchor selection test (e.g., which anchors should see each other, the expected distances, the expected signal power range), so the system 100 can take action when conditions are out of tolerance. For example, if a sensor 40 is judged to have moved too far, the anchor selection algorithm may ignore the ranging results from the identified sensor 40, add an offset to results from the identified sensor 40, or provide less weight to the results from the identified sensor 40.

### B. Dynamic Sensor Selection

In one embodiment, the system 100 may be configured to dynamically select which sensor 40 participates in a particular ranging round for determining a location of the remote device 40 relative to the object 10. Optionally, the sensors 40 from which the system 100 may select have been identified from an operational test (e.g., a self-test) conducted in accordance with one or more embodiments described herein. Step 1006.

The system 100 may be configured to do the selection of sensors 40 between ranging rounds based on one or more factors, such as an algorithm state. Alternatively, or additionally, the system 100 may select sensors 40 via a pre-poll/poll message receipt inside the ranging round for determining the location of the remote device 40 relative to the object 10. The pre-poll/poll message may correspond to one or more performance metrics of communications (e.g., RSSI, time of flight, time of arrival, or any other characteristic of communications described herein) between a sensor 40 and any one or more of another sensor 40, the object device 50, and the remote device 20. Steps 1008, 1010. With a subset of sensors 40 selected for a ranging round, each of the sensors 40 may participate in the ranging round according to a ranging procedure, which may be conducted according to one or more embodiments described herein, such as each sensor 40 being an initiator, responder, or sniffer, or a combination thereof. Step 1012. Ranging rounds may repeated conducted, as described herein, and the system 100, for each round, may re-use or re-determine the subset of sensors 40 to utilize for a ranging round. A re-determination may include the dynamic selection of sensors considered operational and/or re-identifying operational sensors as well as dynamic selection of such re-identified operational sensors.

In one embodiment, the system 100 may be configured to dynamically select which sensors 40 to participate (at what responder indexes) based on receipt of pre-poll/poll messages. Due to the short timing between poll and responses, the system 100 can be dynamically configured to change the later responders in the ranging round to increase or maximize the amount of time on the bus (e.g., the channels available for communication). The system 100 may be configured such that the object device 50 (e.g., an SCM) controls selection of sensors 40 centrally—e.g., each sensor 40 sends a message to the object device 50 when it observes a poll message—and then the object device 50 collects all of the messages from the sensors 40 and, based on these messages, decides whether to change which sensors 40 will participate in the ranging round. In this way, a ranging round may involve a number of sensors 40 that are likely to yield quality ranging results for a given available amount of bandwidth for a ranging round.

In one embodiment, a connection between one or more sensors 40 and the remote device 20 may be tracked (e.g., via signal strength.) An algorithm, such as a machine learning algorithm, may be operable to detect coarsely which sensors 40 are the closest to the remote device 20. Some sensors 40 may be in a fading zone (e.g., obscured). However, as an example, the remote device 20 is being located in a subway system, the fade may already be gone by the time the system 100 begins the actual operation and so the algorithm may be configured to account for such temporary fading effects.

Additionally, or alternatively, each sensor 40 in the system 100 may send a broadcast so that it is possible for each other sensor 40 and/or the object device 50 to observe the broadcast. The sensors 40 may then reconfigure themselves based on a local enable/disable determination and/or at the directive of another device, such as another sensor 40 and/or the object device 50.

Additionally, or alternatively, the sensors 40 may send directed messages to each other. For example, with a system 100 configured with a session setup for ten sensors 40, but the object 10 has sixteen sensors 40 installed on it, the system 100 may be configured so that responder indexes 0 . . . 6 never change within a round, but 7 . . . 9 may swap dynamically (e.g., anchors 8-12 or 12-16 or some other combination). In this particular configuration, the system 100 may have 7-8 slots worth of time to change the configuration across the communication channel 130 (e.g., the CAN bus), which may take at least a portion of time, such as from 7-8 ms with 1 ms slots and 14-16 ms with 2 ms slots.

One or more embodiments of dynamic selection of the present disclosure may provide a system 100 that is scalable in terms of the number of sensors that can be installed on an object, where the system 100 selects the sensors 40 that are visible, in terms of communications with each other and/or the remote device 40, to respond.

In one embodiment, the system 100 may be configured to adjust later sensors 40 in the sequence within a ranging round, and adjust earlier sensors 40 between rounds based on previous observations. In this way, all or many of the sensors 40 can observe the poll/pre-poll, but not all sensors 40 may be able to respond in the ranging round, with the system 100 being operable to enhance or maximize the number of sensors 40 participating in the ranging round across all sensors 40 installed on the object 10.

In one embodiment, the system 100 may be configured to dynamically repeat sensors 40 that observe the poll multiple times in the ranging round if there are empty slots in the round (due to responders not being able to participate because they do not observe the pre-poll/poll). For instance, if the system 100 is configured to always fill X number of slots (e.g., ten slots), the system 100 may be configured to repeat a ranging procedure with one or more sensors 40 in the case where less than X number of sensors 40 is operational or able to participate.

Information about the signals transmitted and/or received with respect to sensors 40 may be used by the system 100 as a basis for determining if a sensor 40 is selected for repetition in a ranging round.

In one embodiment, the system 100 operating with dynamic selection capabilities may provide power savings, where not all sensors 40 may be running procedures during all ranging rounds.

In one embodiment, the system 100 may be provided in a public transportation system. For instance, any type of vehicle that is lengthy may benefit from a dynamic network of sensors 40, where dynamic allocation of a subset of sensors 40 may operate better than a handoff from one subset of sensors 40 to another. A bus, train, or subway may utilize such a system 100. As another example, vehicles provide in a line or queue for an object 10 (e.g., a building) may take advantage of dynamic selection of sensors 40 in a system 100. Drive-thrus or toll booths are additional examples where localization along with coordinating payment may be utilized with dynamic selection in the system 100.

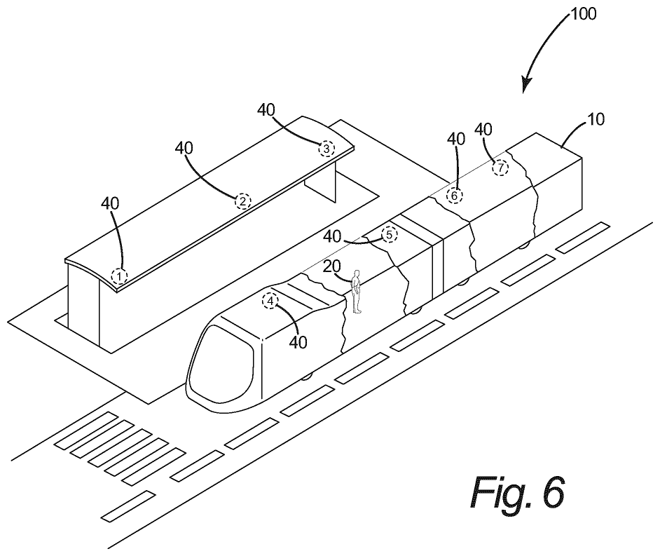

A system 100 according to one embodiment is shown in FIG. 6 with a vehicle in the form of a train that is lengthy and includes a plurality of sensors 40, along with a stop for the train including a plurality of sensors 40, such as the station described in U.S. Pat. No. 11,272,559, entitled SYSTEM AND METHOD OF DETERMINING REAL-TIME LOCATION, to Smith, issued Mar. 8, 2022—the disclosure of which is hereby incorporated by reference in its entirety. As the remote device 20 is carried by a user relative to the sensors 40, the sensors 40 may be dynamically selected according to one or more embodiments described herein. For instance, the sensors 40 labeled 1, 2, 3, 4, 5, 6, and 7 may be dynamically selected for a ranging procedure as the remote device 30 is carried by the user from along the station stop to the train and along the train.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

1. A system for determining a distance between a remote device and an object, the system comprising:
a first device disposed in a fixed position relative to the object, the first device configured to conduct a first device ranging procedure with respect to the remote device based on communications with the remote device;
a second device disposed in a fixed position relative to the object, the second device operable to communicate with the first device; and
a control system configured to determine, based on communications between the first device and the second device, if the first device is acceptably operational for conducting the first device ranging procedure, the control system configured to direct the first device to abstain from conducting the first device ranging procedure based on the first device failing to be determined as acceptably operational for conducting the first device ranging procedure.

2. The system of claim 1 comprising:
a third device disposed in a fixed position relative to the object, the third device configured to conduct a third device ranging procedure with respect to the remote device based on communications with the remote device; and
the control system configured to determine, based on communications between the third device and the second device, if the third device is acceptably operational for conducting the third device ranging procedure, the control system directing the third device to conduct the third device ranging procedure based on the third device being determined to be acceptably operational and directing the first device to abstain from conducting the first device ranging procedure based on the first device failing to be determined as acceptably operational for conducting the first device ranging procedure.

3. The system of claim 1 wherein the second device is configured to conduct a second device ranging procedure with respect to the remote device based on communications with the remote device.

4. The system of claim 3 wherein the control system is provided at least in part in a third device, and wherein the control system is configured to determine, based on communications between the first device and the second device, if the second device is acceptably operational for conducting the second device ranging procedure.

5. The system of claim 3 wherein the control system is operable to dynamically select one of the first and second devices to conduct the respective first and second device ranging procedures during a round of ranging procedures that includes more than one device conducting a ranging procedure with respect to the remote device.

6. The system of claim 1 wherein the control system is provided at least in part in the second device.

7. The system of claim 1 wherein the control system determines the first device has failed to be acceptably operational based on at least one of the first device malfunctioning, the first device having moved from a known location, and an antenna system of the first device is communicating in a manner out of specification.

8. The system of claim 1 wherein the first device and the second device each include a backchannel interface operable to facilitate backchannel communications with the control system, and wherein the control system is configured to determine at least one of the first and second devices fails to operate acceptably based on the backchannel communications failing to operate within acceptable parameters.

9. A system for determining a distance between a remote device and an object, the system comprising:
a plurality of devices disposed in a fixed position relative to the object, each of the plurality of devices configured to conduct a ranging procedure with respect to the remote device based on communications with the remote device;
a first device among the plurality of devices, the first device configured to conduct a first device ranging procedure with respect to the remote device based on communications with the remote device; and
a control system configured to direct dynamic selection of a subset of the plurality of devices to conduct the respective ranging procedures based on communications with the remote device during a ranging round, the control system configured to select the first device to be within the subset of the devices based on a performance metric pertaining to communications between the first device and at least one of the remote device and a second device disposed in a fixed position relative to the object.

10. The system of claim 9 wherein the second device is one of the plurality of devices configured to conduct a ranging procedure with respect to the remote device based on communications with the remote device.

11. The system of claim 9 wherein the control system is configured to exclude the first device from the subset of the devices based on the performance metric.

12. The system of claim 9 wherein a performance metric is determined for communications for each of the plurality of devices.

13. The system of claim 9 wherein the second device includes the control system.

14. The system of claim 9 wherein the performance metric is determined between ranging rounds, and wherein the control system is operable to select a new subset of the plurality of devices between each ranging round.

15. The system of claim 9 wherein the performance metric is determined during a ranging round, and wherein the control system is operable to determine whether to include the first device in the subset of devices during the ranging round.

16. The system of claim 9 wherein the performance metric is determined prior to an initial ranging round.

17. The system of claim 9 wherein the control system directs the first device to conduct the first device ranging procedure more than once during a ranging round.

18. The system of claim 9 wherein the control system is configured to determine if the first device is acceptably operational for conducting the first device ranging procedure.

19. The system of claim 18 wherein the control system is configured to determine if the first device is acceptably operational based on the performance metric.

20. The system of claim 18 wherein the control system is configured to determine if each of the plurality of devices is acceptably operational for conducting a ranging procedure and to exclude from the subset of the plurality of devices any of the plurality of devices that fail to be determined as acceptably operational.

21. A system for determining a distance between a remote device and an object, the system comprising:
a plurality of devices disposed in a fixed position relative to the object, each of the plurality of devices configured to conduct a ranging procedure with respect to the remote device based on communications with the remote device;
a first device among the plurality of devices, the first device configured to conduct a first device ranging procedure with respect to the remote device based on communications with the remote device;
a control system configured to direct dynamic selection of a subset of the plurality of devices to conduct the respective ranging procedures based on communications with the remote device during a ranging round, the control system configured to determine if the first device is acceptably operational for conducting the first device ranging procedure; and
the control system configured to select the first device to be within the subset of the devices based on 1) the first device being acceptably operational and 2) a performance metric pertaining to communications between the first device and at least one of the remote device and a second device disposed in a fixed position relative to the object.

22. The system of claim 21 wherein the control system determines the first device has failed to be acceptably operational based on at least one of the first device malfunctioning, the first device having moved from a known location, and an antenna system of the first device is communicating in a manner out of specification.

23. The system of claim 21 wherein each of the plurality of devices includes a backchannel interface operable to facilitate backchannel communications with the control system, and wherein the control system is configured to determine the first device fails to operate acceptably based on the backchannel communications failing to operate within acceptable parameters.

24. The system of claim 21 wherein the second device is one of the plurality of devices configured to conduct a ranging procedure with respect to the remote device based on communications with the remote device.

25. The system of claim 21 wherein the control system is configured to exclude the first device from the subset of the devices based on the performance metric.

26. The system of claim 21 wherein a performance metric is determined for communications for each of the plurality of devices.

27. The system of claim 21 wherein the performance metric is determined between ranging rounds, and wherein the control system is operable to select a new subset of the plurality of devices between each ranging round.

28. The system of claim 21 wherein the performance metric is determined during a ranging round, and wherein the control system is operable to determine whether to include the first device in the subset of devices during the ranging round.

29. The system of claim 21 wherein the performance metric is determined prior to an initial ranging round.

30. The system of claim 21 wherein the control system directs the first device to conduct the first device ranging procedure more than once during a ranging round.
